(19) United States
(12) Patent Application Publication
(10) Pub. No.: US 2026/0168140 A1
(43) Pub. Date: Jun. 18, 2026

(54) THREADLIKE ADHESIVE BODY

(71) Applicant: NITTO DENKO CORPORATION, Ibaraki-shi, Osaka (JP)

(72) Inventors: Hiromitsu MORISHITA, Ibaraki-shi, Osaka (JP); Kayo SHIMOKAWA, Ibaraki-shi, Osaka (JP); Narumi TSUKAMOTO, Ibaraki-shi, Osaka (JP); Atsushi TAKASHIMA, Ibaraki-shi, Osaka (JP); Yosuke MAKIHATA, Ibaraki-shi, Osaka (JP)

(21) Appl. No.: 19/128,833

(22) PCT Filed: Nov. 9, 2023
(86) PCT No.: PCT/JP2023/040410

§ 371 Date: May 9, 2025

(30) Foreign Application Priority Data
Nov. 11, 2022 (JP) 2022-181322

(51) Int. Cl. D02G 3/40; D02G 3/02; D02G 3/44

(52) U.S. Cl. CPC D02G 3/404; D02G 3/02; D02G 3/44; D10B 2331/04; D10B 2505/00

(57) ABSTRACT

An object of the present invention is to provide a threadlike adhesive body that can maintain excellent adhesive strength while preventing self-adhesion even as a wound body. The present invention relates to a threadlike adhesive body containing a core material and an adhesive, in which an area ratio in a cross section of the threadlike adhesive body calculated by the following Formula (1) is 0.2 to 1.0. (Area ratio)=(Area of adhesive)/(Area of core material) (1)

### TECHNICAL FIELD

The present invention relates to a threadlike adhesive body.

### BACKGROUND ART

A threadlike adhesive body containing a core material and an adhesive is generally made by coating a periphery of the core material with the adhesive, and is a thin adhesive body capable of conforming to a complex shape. When storing and transporting the threadlike adhesive body, the threadlike adhesive body can be made into a wound body by being wound into a cylindrical shape using a bobbin as necessary, and since no release liner is required, waste during a process can be reduced.

As the threadlike adhesive body, for example, those described in Patent Literatures 1 and 2 are disclosed.

### CITATION LIST

### Patent Literature

Patent Literature 1: WO2020/071508
Patent Literature 2: WO2022/071241

### SUMMARY OF INVENTION

### Technical Problem

The threadlike adhesive body described in Patent Literature 1 has excellent adhesive strength, and the threadlike adhesive body described in Patent Literature 2 has excellent impact resistance.

On the other hand, the threadlike adhesive body stored and transported as a wound body has a problem of adhesion between the threadlike adhesive bodies. This problem is also called self-adhesion, and causes deterioration in handleability of the threadlike adhesive body in use. In Patent Literatures 1 and 2, no sufficient study was conducted to solve such a problem of self-adhesion.

The present invention has been made in consideration of the above-mentioned situation in the related art, and an object thereof is to provide a threadlike adhesive body that can maintain excellent adhesive strength while preventing self-adhesion even as a wound body.

### Solution to Problem

As a result of diligent study to solve the above-mentioned problem, inventors of the present invention found that the above-mentioned problem can be solved by setting a ratio of an area of the adhesive to an area of the core material in a cross section of the threadlike adhesive body to a specific range, thereby obtaining the present invention.

That is, the present invention relates to the following.

[1]

A threadlike adhesive body, containing:
a core material; and
an adhesive, in which
an area ratio in a cross section of the threadlike adhesive body calculated by the following Formula (1) is 0.2 to 1.0.

$$( Area ratio ) = ( Area of adhesive ) / ( Area of core material ) \qquad ( 1 )$$

[2]

The threadlike adhesive body according to [1], in which
the number of filaments contained in the core material is four or more.
   [3]

The threadlike adhesive body according to [1] or [2], in which
a porosity in the cross section of the threadlike adhesive body is 20 area % or less.
   [4]

The threadlike adhesive body according to [1] or [2], in which
the number of twists of the core material is 1 twist/m to 500 twists/m.
   [5]

The threadlike adhesive body according to [1] or [2], in which
an elastic modulus of the adhesive at 23° C. is 1.0×10³ Pa to 1.0×10⁷ Pa.

### Advantageous Effects of Invention

The threadlike adhesive body of the present invention can maintain excellent adhesive strength while preventing self-adhesion even as a wound body.

### DESCRIPTION OF EMBODIMENTS

Hereinafter, an embodiment of a threadlike adhesive body of the present invention will be described in detail.

The present invention is not limited to the embodiment to be described below. When an expression “to” is used in the present specification, it is used as an expression including numerical values or physical property values before and after it.

In the present specification, the threadlike adhesive body wound into a cylindrical shape, if necessary using a cylindrical body such as a bobbin, is referred to as a wound body.

The wound body may or may not include the cylindrical body such as a bobbin.

### [Threadlike Adhesive Body]

The threadlike adhesive body of the present embodiment contains a core material and an adhesive.

Here, the threadlike refers to a shape in which a length in a longitudinal direction is sufficiently longer than a length in a width direction, a ratio of a length of a long axis to a length of a short axis in a cross-sectional shape (long axis/short axis) is, for example, 200 or less, and the shape can be bent in various directions and at various angles like a thread.

A cross section refers to a plane obtained by cutting an object perpendicular to the longitudinal direction. The cross-sectional shape means a shape of the cross section. The short axis means the shortest axis passing through a center of gravity of the cross-sectional shape. The long axis means the longest axis passing through the center of gravity of the cross-sectional shape. The ratio of long axis/short axis is preferably 100 or less, more preferably 50 or less, still more preferably 10 or less, particularly preferably 5 or less, and most preferably 3 or less.

The threadlike adhesive body of the present embodiment can be bent in various directions and at various angles, and therefore can be bent to match a shape of a bonding area, and can respond to a variety of shapes of the bonding area.

### <Core Material>

The threadlike adhesive body of the present embodiment contains the core material. The core material is preferably in a form of a thread.

The core material is a multifilament yarn containing a plurality of filaments and formed by making the plurality of filaments into a composite yarn or a twisted yarn. When the core material is a multifilament yarn, sufficient strength and stable physical properties can be obtained. As a result, it is possible to obtain a threadlike adhesive body that has low variation in quality, excellent strength, and excellent adhesive strength.

From the viewpoint of adhesive strength, the number of filaments contained in the core material is preferably 4 or more, more preferably 10 or more, and particularly preferably 20 or more.

On the other hand, if a thickness (fineness) of the core material is kept at the same level, as the number of filaments increases, each filament becomes thinner (has a smaller fineness). If each filament becomes too thin, it may result in a decrease in the strength of the core material and a decrease in handleability, and therefore, the number of filaments is preferably 2000 or less, more preferably 1500 or less, and particularly preferably 1000 or less.

There is no particular limitation on a type of resin used for the filaments, and the type of resin may be appropriately selected depending on required properties such as strength, mass, and hardness. For example, materials including polymeric materials such as thermoplastic polymers, thermosetting polymers, and rubbers can be used.

Specifically, polymeric materials such as rayon, cupra, acetate, promix, nylon, aramid, vinylon, vinylidene, polyvinyl chloride, acrylic, polyolefin (polyethylene, polypropylene, ethylene-propylene copolymer, ethylene-vinyl acetate copolymer, and the like), polyester resin (polyethylene terephthalate, and the like), vinyl chloride resin, vinyl acetate resin, polyimide resin, polyamide resin, fluororesin, polyurethane, polyclar, and polylactic acid; rubbers such as synthetic rubber (natural rubber, polyurethane, and the like); foams such as polyurethane foam and polychloroprene rubber foam; and the like can be used. Among these, polyester resin is preferred, and polyethylene terephthalate is more preferred.

A content of the filaments in the core material is preferably 10 mass % to 100 mass %, more preferably 50 mass % to 100 mass %, and particularly preferably 80 mass % to 100 mass %, from the viewpoint of preventing impregnation of the core material with the adhesive.

The core material may contain various additives such as a filler (an inorganic filler, an organic filler or the like), an anti-aging agent, an antioxidant, an ultraviolet absorber, an antistatic agent, a lubricant, a plasticizer, and a colorant (a pigment, a dye, or the like) as necessary. The known or common surface treatment such as a corona discharge treatment, a plasma treatment or application of an undercoat agent may be performed on a surface of the core material.

A shape of the core material is not particularly limited, and may be appropriately adjusted depending on required properties such as strength, mass, and hardness.

A cross-sectional shape of the core material is typically circular, and may be various shapes such as an elliptical shape and a polygonal shape in addition to the circular shape.

The core material may contain a plurality of filaments, and may be a combined yarn obtained by twisting the filaments and spun yarns, finished yarns, hollow yarns, or the like together. Examples of the finished yarns include those have been subjected to crimping process or bulking processes and are generally called textured yarns, bulky yarns, and stretch yarns.

A thickness of the core material is not particularly limited, and may be appropriately adjusted so that the thickness of the threadlike adhesive body is appropriate depending on a use thereof.

The number of twists of the core material is preferably 1 twist/m or more. When the number of twists is 1 twist/m or more, it becomes easy to form voids as described below, and impact resistance of the threadlike adhesive body is improved. The number of twists of the core material is more preferably 20 twists/m or more, and still more preferably 50 twists/m or more.

On the other hand, in order to ensure that the core material is sufficiently deformed when a plurality of articles are bonded together, and in order to increase an adhered amount of the adhesive per unit length, it is preferable that the core material is not twisted too tightly. Therefore, the number of twists of the core material is preferably 500 twists/m or less, more preferably 300 twists/m or less, and still more preferably 100 twists/m or less.

When the core material is twisted, it is preferable to also control a twist coefficient K represented by the following Formula (A) from the same viewpoint as above. The twist coefficient K is an index for discussing an influence of twisting (influence on cohesion, ease of deformation, the adhered amount of the adhesive, and the like of the core material) regardless of the thickness of the core material. In other words, the influence of the number of twists on the core material varies depending on the thickness of the core material, but if the twist coefficient K is the same, the influence of twisting on the core material is the same regardless of the thickness of the core material.

The twist coefficient K is preferably 0 or more, and more preferably greater than 0. On the other hand, if the twist coefficient K is 200 or less, flexibility of the core material, and even the threadlike adhesive body, is improved, making it easier to be applied to curved portions, bent portions, uneven portions or other complicated shapes and narrow portions. Therefore, the twist coefficient K is preferably 200 or less, more preferably 100 or less, and still more preferably less than 50.

$$[ Math . 1 ]$$

$$K = T / \sqrt{10 \; 000 / D} \qquad ( A )$$

In Formula (A), K is the twist coefficient, T is the number of twists (twists/m), and D is the fineness (dtex).

### <Adhesive>

The threadlike adhesive body of the present embodiment contains the adhesive. The core material is covered with and impregnated with the adhesive.

It is preferable that the adhesive covers an entire circumference of a surface of the core material in the longitudinal direction. The entire circumference of the surface of the core material refers to an entire peripheral surface of the core material, and means the entire 360° circumference of the surface of the core material, centered on a center line of the core material in the longitudinal direction.

However, an end surface of the core material may or may not be covered with the adhesive. For example, when the threadlike adhesive body is cut during production or during use, the end surface of the core material may not be covered with the adhesive.

By covering the entire circumference of the surface of the core material in the longitudinal direction with the adhesive, a threadlike adhesive body having excellent strength can be obtained. This is presumably because the core material is not exposed to the surface, thereby preventing stress from concentrating on one part of the core material and causing breakage.

A coverage of the core material with the adhesive (area (%) of the adhesive per unit area of the surface of the core material) is preferably 50 area % or more, more preferably 80 area % or more, still more preferably 90 area % or more, and particularly preferably 95 area % or more. When the coverage of the core material is 50 area % or more, breakage of the core material is prevented, and a threadlike adhesive body having excellent strength can be obtained.

The coverage of the core material can be calculated, for example, using an X-ray CT device (Xradia 520 Versa, manufactured by Zeiss, tube voltage 60 kV, tube current 83 μA, pixel size 1.5 μm/pixel). Specifically, 1601 continuous transmission images are taken from 0° to 360° around the entire circumference of the threadlike adhesive body. The obtained images are three- dimensionally reconstructed to obtain data using image analysis software (ImageJ, AVIZO (manufactured by Thermo Fisher Scientific)) to identify the core material, the adhesive, and air by performing ternary value conversion and noise removal based on brightness. Note that this identification is performed by checking the brightness of air and the adhesive separately and setting a first threshold using an intermediate value thereof, and then checking the brightness of the adhesive and the core material separately and setting a second threshold using an intermediate value thereof. An area of a core material-air interface (Interface 1) and an area of a core material-adhesive interface (Interface 2) are calculated using the images obtained after the ternary value conversion, and then the coverage is calculated by the following formula.

$$Coverage ( \% ) = \{ Area of Interface 2 / ( Area of Inferface 1 + Area of Interface 2 ) \} \times 100$$

Note that Interface 1 does not include an interface between the core material and the voids in the threadlike adhesive body of the present embodiment. When the filament is a hollow yarn, Interface 1 does not include an interface between the core material and voids in the filament.

Furthermore, Interface 2 is intended as the interface between the adhesive and air. Interface 2 does not include the interface between the adhesive and the voids in the threadlike adhesive body of the present embodiment. When the filament is a hollow yarn, Interface 2 does not include the interface between the adhesive and the voids in the filament.

Here, “the core material is impregnated with the adhesive” means that the adhesive is present among the plurality of filaments in the core material. When the core material is impregnated with the adhesive, the adhesive and the core material maintain adhesion therebetween and are hard to peel off from each other, thereby improving the strength of the threadlike adhesive body.

The adhesive is not particularly limited, and any known adhesive can be used. Examples thereof include an acrylic adhesive, a rubber-based adhesive, a vinyl alkyl ether-based adhesive, a silicone-based adhesive, a polyester-based adhesive, a polyamide-based adhesive, a urethane-based adhesive, a fluorine-based adhesive, and an epoxy-based adhesive. Among these, from the viewpoint of adhesiveness, the acrylic adhesive, urethane-based adhesive, silicone-based adhesive, rubber-based adhesive, and polyester-based adhesive are preferred, and the acrylic adhesive is particularly preferred since the adhesiveness can be easily controlled. Note that one kind of the adhesive may be used alone, or two or more kinds thereof may be used in combination. The adhesive in the present embodiment is preferably a pressure-sensitive adhesive that has adhesiveness at a room temperature and can be stuck to a surface of an adherend by a pressure generated when a surface of the adhesive and the surface of the adherend are brought into contact with each other. When the adhesive is a pressure-sensitive adhesive, the adhesive does not need to be heated and can be applied to an adherend that is sensitive to heat.

Note that as the adhesive, either a solvent-type adhesive or a water-dispersible adhesive can be used, and it is preferable that crosslinking is performed by drying (solvent volatilization or heating) an adhesive composition and the crosslinking is rapidly completed after drying. This is because new crosslinking does not increase after surfaces of the adhesive come into contact with each other. Here, from the viewpoint of enabling high-speed coating, being environmentally friendly, and having a small influence (swelling or dissolution) on a base or the core material caused by a solvent, the water-dispersible adhesive is preferred, and a water-dispersible acrylic adhesive is more preferred.

Here, the term “acrylic adhesive” refers to an adhesive containing an acrylic polymer as a base polymer (a main component of polymer components, that is, a component that accounts for 50 mass % or more). The term “acrylic polymer” refers to a polymer having a monomer having at least one (meth)acryloyl group in one molecule (hereinafter, this may be referred to as an “acrylic monomer”) as a main constituent monomer component (a main component of the monomer, that is, a component that accounts for more than 50 mass % of a total amount of monomers that constitute the acrylic polymer). In the present specification, the term “(meth)acryloyl” comprehensively refers to acryloyl and methacryloyl. Similarly, the term “(meth)acrylic acid ester” comprehensively refers to acrylic acid ester and methacrylic acid ester, and the term “(meth)acrylic” comprehensively refers to acrylic and methacrylic.

The acrylic polymer is preferably, for example, a polymer of a monomer raw material that contains alkyl (meth)acrylate as a main monomer and may further contain a sub-monomer copolymerizable with the main monomer. The main monomer herein refers to a component that accounts for more than 50 mass % of the monomer composition in the monomer raw material.

As the alkyl (meth)acrylate, examples thereof include a compound represented by General Formula (3).

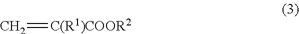

(In the formula, R¹ represents a hydrogen atom or a methyl group, and R² represents an alkyl group having 2 to 14 carbon atoms.)

Examples of R² include an ethyl group, a propyl group, an isopropyl group, a butyl group, an isobutyl group, an isoamyl group, a hexyl group, a heptyl group, a 2-ethylhexyl group, an isooctyl group, an isononyl group, and an isodecyl group. Among these, as R², an alkyl group having 2 to 10 carbon atoms, such as a butyl group and a 2-ethylhexyl group, is preferred. The above alkyl (meth)acrylate can be used alone or in combination of two or more kinds thereof.

In a monomer mixture containing the alkyl (meth)acrylate as a main component, a ratio of the alkyl (meth)acrylate [for example, the above-mentioned (meth)acrylic acid C₂₋₁₄ alkyl ester] is generally 80 mass % or more (for example, about 80 mass % to 99.8 mass %), preferably 85 mass % or more (for example, about 85 mass % to 99.5 mass %), and more preferably 90 mass % or more (for example, about 90 mass % to 99 mass %).

The monomer mixture generally contains a functional group-containing monomer (thermally crosslinkable functional group-containing monomer) in order to introduce crosslinking points for thermal crosslinking. By using the functional group-containing monomer as a comonomer component, the adhesive strength to the adherend is also improved.

Examples of the functional group-containing monomer include carboxyl group-containing monomers or acid anhydrides thereof, such as acrylic acid, methacrylic acid, itaconic acid, maleic acid, crotonic acid, and maleic anhydride; hydroxyl group-containing monomers, such as 2-hydroxyethyl (meth)acrylate, 2-hydroxypropyl (meth)acrylate, and 2-hydroxybutyl (meth)acrylate; amide group-containing monomers, such as (meth)acrylamide, N,N-dimethyl (meth)acrylamide, N-methylol (meth)acrylamide, N-methoxymethyl (meth)acrylamide, and N-butoxymethyl (meth)acrylamide; amino group-containing monomers, such as dimethylaminoethyl (meth)acrylate and t-butylaminoethyl (meth)acrylate; glycidyl group-containing monomers, such as glycidyl (meth)acrylate; (meth)acrylonitrile, N-(meth)acryloylmorpholine, and N-vinyl-2-pyrrolidone. Among these, the carboxyl group-containing monomers such as acrylic acid or acid anhydrides thereof are preferred. The above functional group-containing monomers may be used alone or in combination of two or more kinds thereof.

The amount of the functional group-containing monomer used is, for example, about 0.5 parts by mass to 12 parts by mass, and preferably about 1 part by mass to 8 parts by mass, based on 100 parts by mass of the alkyl (meth)acrylate.

The monomer mixture may contain other copolymerizable monomers as necessary in order to improve properties such as cohesive strength. Examples of such copolymerizable monomers include methyl (meth)acrylate: vinyl esters such as vinyl acetate; aromatic vinyl compounds such as styrene and vinyl toluene; (meth)acrylic acid esters of cyclic alcohols such as cyclopentyl di(meth)acrylate and isobornyl (meth)acrylate; and (meth)acrylic acid esters of polyhydric alcohols such as neopentyl glycol di(meth)acrylate, hexanediol di(meth)acrylate, propylene glycol di(meth)acrylate, trimethylolpropane tri(meth)acrylate, tetramethylolmethane tri(meth)acrylate, and dipentaerythritol hexa(meth)acrylate. These copolymerizable monomers can also be used alone or in combination of two or more kinds thereof.

It is also preferable to add a crosslinking agent to these acrylic adhesives. As the crosslinking agent used for the acrylic adhesives, a commonly used crosslinking agent can be used, and examples thereof include silane-based crosslinking agents, organic peroxides, epoxy-based compounds, amino group-containing compounds, organic metal salts, metal alcoholates, metal chelates, hydrazide-based crosslinking agents, carbodiimide-based crosslinking agents, isocyanate-based crosslinking agents, and silanol-based crosslinking agents. Among these, organic metal salts, metal chelates, hydrazide-based crosslinking agents, and silane-based crosslinking agents are preferred since crosslinking is rapidly completed after the adhesive composition is dried. In the case of a water-dispersible adhesive, a hydrazide-based crosslinking agent and a silane-based crosslinking agent are particularly preferred. The crosslinking agent may be either oil-soluble or water-soluble, and may be used alone or in combination of two or more kinds thereof.

As the silane-based crosslinking agent, it is preferable to use a silane-based monomer copolymerizable with the above-mentioned alkyl (meth)acrylate. The silane-based monomer is not particularly limited as long as it is a polymerizable compound having a silicon atom, and a silane compound having a (meth)acryloyl group, such as a (meth)acryloyloxyalkylsilane derivative, is preferred because of excellent copolymerizability thereof with the above-mentioned alkyl (meth)acrylate. Examples of the silane-based monomer include γ-methacryloxypropyltrimethoxysilane, 3-acryloyloxypropyltrimethoxysilane, 3-methacryloyloxypropyltriethoxysilane, 3-acryloyloxypropyltriethoxysilane, 3-methacryloyloxypropylmethyldimethoxysilane, 3-acryloyloxypropylmethyldimethoxysilane, 3-methacryloyloxypropylmethyldiethoxysilane, and 3-acryloyloxypropylmethyldiethoxysilane. These silane-based monomers can be used alone or in combination of two or more kinds thereof.

In addition to the above, examples of copolymerizable silane-based monomers that can be used include vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

The amount of the crosslinking agent used can be appropriately selected depending on the type of the monomer raw material and the application of the threadlike adhesive body. In the present embodiment, the amount of the crosslinking agent relative to 100 parts by mass of the monomer raw material (excluding the crosslinking agent) is preferably in the range of 0.005 parts by mass to 5 parts by mass, and more preferably 0.01 part by mass to 3 parts by mass.

In the present embodiment, other crosslinking may also be used, and crosslinking using other crosslinking agents, UV crosslinking, radiation crosslinking such as electron beam crosslinking, and the like can be applied. As the other crosslinking agent, a commonly used crosslinking agent can be used, and examples thereof include organic peroxides, epoxy compounds, amino group-containing compounds, organic metal salts, metal alcoholates, metal chelates, hydrazide crosslinking agents, carbodiimide crosslinking agents, isocyanate crosslinking agents, and silane or silanol crosslinking agents. The other crosslinking agents may be either oil-soluble or water-soluble.

The adhesive can be formed using an adhesive composition, and the adhesive composition is preferably a water-dispersible adhesive composition. Note that the adhesive may form a layer (adhesive layer).

The water-dispersible adhesive composition can be prepared, for example, by subjecting a monomer mixture containing the above-mentioned alkyl (meth)acrylate as a main component and a silane-based monomer to common emulsion polymerization to obtain an aqueous dispersion of a (meth)acrylic acid ester copolymer, and adding thereto, as necessary, the above-mentioned other crosslinking agent.

The reason why such excellent effects are achieved when using the above-mentioned water-dispersible adhesive composition containing the alkyl (meth)acrylate as a main component and a silane-based monomer is not necessarily clear, but intramolecular chains connecting crosslinking points within polymer molecules are long, making the polymer chains less likely to unravel. Since there is no water present after drying, hydrolysis does not occur, and even when adhesives of adhesive bodies come into contact with each other, condensation reactions or crosslinking reactions do not proceed, and therefore, reactions between the adhesives are unlikely to occur and self-adhesion is unlikely to occur. Therefore, it is presumed that even when the adhesive body is wound into a roll without a release liner, or a plurality of the adhesive bodies are stacked and the adhesives come into contact with each other, peeling will be easy at adhesive interfaces.

As the polymerization method, general batch polymerization, continuous dropwise polymerization, divided dropwise polymerization, and the like can be adopted, and a polymerization temperature is, for example, about 20° C. to 100° C.

Examples of a polymerization initiator used in the polymerization include, but are not limited to, azo-based initiators such as 2,2′-azobis [N-(2-carboxyethyl)-2-methylpropionamidine]n-hydrate, 2,2′-azobisisobutyronitrile, 2,2′-azobis(2-methylpropionamidine)disulfate, 2,2′-azobis(2-amidinopropane) dihydrochloride, 2,2′-azobis [2-(5-methyl-2-imidazolin-2-yl) propane]dihydrochloride, and 2,2′-azobis(N,N′-dimethylene); persulfates such as potassium persulfate and ammonium persulfate; peroxide-based initiators such as benzoyl peroxide, t-butyl hydroperoxide and hydrogen peroxide; substituted ethane-based initiators such as phenyl-substituted ethane; aromatic carbonyl compounds; and redox-based initiators such as a combination of a persulfate and sodium hydrogen sulfite and a combination of a peroxide and sodium ascorbate. The amount of the polymerization initiator used is, for example, about 0.005 parts by mass to 1 part by mass with respect to 100 parts by mass of the total amount of the monomers.

A chain transfer agent may be used in the polymerization. Examples of the chain transfer agent include common chain transfer agents, such as mercaptans such as lauryl mercaptan and dodecanethiol. An amount of the chain transfer agent used is, for example, about 0.001 part by mass to 0.5 parts by mass with respect to the total amount of 100 parts by mass of the monomers.

As an emulsifier, anionic emulsifiers such as sodium lauryl sulfate, polyoxyethylene sodium lauryl sulfate, ammonium lauryl sulfate, sodium dodecylbenzenesulfonate, polyoxyethylene alkyl ether sodium sulfate, polyoxyethylene alkyl phenyl ether ammonium sulfate, and polyoxyethylene alkyl phenyl ether sodium sulfate; and nonionic emulsifiers such as polyoxyethylene alkyl ether and polyoxyethylene alkyl phenyl ether can be used. These emulsifiers may be used alone or in combination of two or more kinds thereof. An amount of the emulsifier used is, for example, about 0.2 parts by mass to 10 parts by mass, and preferably about 0.5 parts by mass to 5 parts by mass, with respect to the total amount of 100 parts by mass of the monomers.

Note that in addition to the above, the adhesive composition may also be prepared by obtaining the (meth)acrylic acid ester copolymer by a method other than emulsion polymerization, adding the crosslinking agent as necessary, and dispersing the obtained mixture in water with the emulsifier.

The adhesive composition may further contain, as necessary, a base (such as aqueous ammonia) or an acid for adjusting the pH thereof, and additives typically used in adhesives, such as an adhesive-imparting resin, a thickener, a surfactant, an anti-aging agent, a filler, a pigment, and a colorant.

As the adhesive-imparting resin, for example, one or two or more kinds selected from various kinds of adhesive-imparting resins such as rosin-based resins, rosin derivative resins, petroleum-based resins, terpene-based resins, phenol-based resins, and ketone-based resins can be used.

A content of the adhesive-imparting resin is preferably 60 parts by mass or less, more preferably 50 parts by mass or less, still more preferably 40 parts by mass or less, and further more preferably 30 parts by mass or less, with respect to 100 parts by mass of a base polymer.

Examples of the thickener include polyacrylic acid-based thickeners, urethane-based thickeners, and polyvinyl alcohol-based thickeners. Among these, the polyacrylic acid-based thickeners and urethane-based thickeners are preferred. A content of the thickener is preferably parts by mass or less, and more preferably 5 parts by mass or less, with respect to 100 parts by mass of the base polymer.

Specifically, an adhered amount of the adhesive (mass of the adhesive per unit length) is preferably 2 mg/m or more, more preferably 5 mg/m or more, and still more preferably 8 mg/m or more. On the other hand, when the adhered amount of the adhesive is excessive, it is necessary to apply the adhesive to the core material a plurality of times in the production process, or it takes time to dry the applied adhesive, resulting in a low production efficiency. Therefore, the adhered amount of the adhesive is preferably 200 mg/m or less, more preferably 180 mg/m or less, and still more preferably 160 mg/m or less.

In the present specification, the adhered amount of the adhesive is sometimes referred to as “glue amount”.

From the viewpoint of improving the adhesive strength of the threadlike adhesive body, an elastic modulus of the adhesive in the threadlike adhesive body at 23° C. is preferably 1.0×10³ Pa to 1.0×10⁷ Pa, more preferably 5.0×10³ Pa to 5.0×10⁶ Pa, and still more preferably 1.0×10⁴ Pa to 1.0×10⁶ Pa.

The elastic modulus of the adhesive at 23° C. can be measured, for example, by an elastic modulus measuring device, a dynamic viscoelasticity measuring device, or the like.

### <Characteristics of Threadlike Adhesive Body>

In the present embodiment, an area ratio in a cross section of the threadlike adhesive body calculated by the following Formula (1) is 0.2 to 1.0, preferably 0.25 to 0.95, more preferably 0.3 to 0.9, and still more preferably 0.4 to 0.8.

(Area ratio)=(Area of adhesive)/(Area of core material) (1)

If the area ratio is less than 0.2, the amount of the adhesive present on an outer periphery of the threadlike adhesive body is insufficient, which undesirably weakens the adhesive strength. In such cases, a thickness of a layer of the adhesive formed on the outer periphery of the threadlike adhesive body is very small, or there are parts on the outer periphery where the layer of the adhesive is not present, resulting in weak adhesive strength.

On the other hand, if the area ratio exceeds 1.0, the amount of the adhesive present on the outer periphery of the threadlike adhesive body becomes excessive, which is undesirable since a problem of self-adhesion is caused. In such cases, a thick layer of the adhesive is formed on the outer periphery of the threadlike adhesive body, and when the threadlike adhesive body is made into a wound body, the adjacent threadlike adhesive bodies in contact with each other adhere strongly to each other, resulting in the problem of self-adhesion.

The area ratio can be determined from an image obtained by observing a cross section of a dyed threadlike adhesive body with a scanning electron microscope (SEM). For dyeing the threadlike adhesive body, for example, heavy metals can be used. In detail, the image obtained by observation with the SEM is binarized by analysis software, the area of the adhesive and the area of the core material corresponding to portions with different colors are determined, and the area ratio is calculated from proportions of these areas. Note that when the analysis is performed also in consideration of an area of the voids described below, the image obtained from the observation with the SEM is subjected to ternary value conversion using analysis software, and the area of the adhesive, the area of the core material, and the area of the voids corresponding to portions with different colors are determined, and the area ratio is calculated from proportions of the area of the adhesive, the area of the core material, and the area of the voids.

The area ratio can be adjusted in various ways. For example, the area ratio can be adjusted by changing amounts of the adhesive and the core material used, by changing a viscosity of a coating liquid when coating the core material with the adhesive, by a coating speed when coating the core material with the adhesive, and the like.

The threadlike adhesive body of the present embodiment preferably has a porosity in the cross section of 20 area % or less, more preferably 19 area % or less, and still more preferably 18 area % or less. If the porosity in the cross section of the threadlike adhesive body is 20 area % or less, the amount of the adhesive with which the core material is impregnated does not become too small, and a certain degree of adhesion is maintained between the adhesive and the core material. Accordingly, it is possible to prevent the threadlike adhesive body from being damaged and the adhesive strength from being reduced due to the core material coming loose or the adhesive being separated from the core material, and therefore is preferable.

A lower limit value of the porosity in the cross section of the threadlike adhesive body is not particularly limited, but from the viewpoint of impact resistance, the porosity is preferably 1 area % or more, more preferably 2 area % or more, and still more preferably 3 area % or more.

The porosity in the cross section of the threadlike adhesive body, as the area ratio, can be determined from an image obtained by observing a cross section of a dyed threadlike adhesive body with a scanning electron microscope (SEM). In detail, the image obtained from the observation with the SEM is subjected to ternary value conversion using analysis software, and the porosity in the cross section of the threadlike adhesive body is calculated from a ratio of the area of the voids to a sum of the area of the adhesive, the area of the core material, and the area of the voids obtained as areas of each color.

The porosity in the cross section of the threadlike adhesive body can be adjusted by various methods. For example, the porosity can be adjusted by changing amounts of the adhesive and the core material used, by changing a viscosity of a coating liquid when coating the core material with the adhesive, by a coating speed when coating the core material with the adhesive, and the like.

A thickness of the threadlike adhesive body is preferably 50 μm to 2000 μm, and more preferably 100 μm to 1000 μm, from the viewpoints of strength and handleability.

[Method for Producing Threadlike Adhesive Body]

The threadlike adhesive body of the present embodiment can be produced by known methods, for example, a method including a coating step of coating the core material with a coating liquid containing the adhesive.

The core material may be coated with the coating liquid by, for example, dipping, immersion, application or the like, and may be dried by heat as necessary.

The heat drying may be performed, for example, at a temperature of 80° C. to 120° C., preferably 90° C. to 110° C., for example, for 20 seconds to 3 minutes, preferably 30 seconds to 2 minutes.

The coating liquid can be applied by using a common coater such as a gravure roll coater, a reverse roll coater, a kiss roll coater, a dip roll coater, a bar coater, a knife coater, and a spray coater.

A method for producing the threadlike adhesive body of the present embodiment may or may not include a fiber opening step. In the fiber opening step, when the core material is coated with the adhesive, the core material is opened by running the core material along a non-rotating roller.

When the threadlike adhesive body of the present embodiment is produced by a method without a fiber opening step, the porosity in the threadlike adhesive body can be adjusted to be high. When the threadlike adhesive body of the present embodiment is produced by a method including a fiber opening step, the porosity in the threadlike adhesive body can be adjusted to be low.

When the method for producing the threadlike adhesive body of the present embodiment includes a coating step, it is preferable that a roller is used in the coating step and a rotation speed of the roller is 0.3 times to 5.0 times a feeding speed of the core material. By keeping the rotation speed of the roller within the above range, the core material is prevented from being opened, making it easier to achieve the porosity of the threadlike adhesive body of the present embodiment within the above range.

The rotation speed of the roller is more preferably 0.4 times to 4.0 times the feeding speed of the core material, further preferably 0.5 times to 3.0 times, and particularly preferably 0.8 times to 1.5 times.

In the coating step, it is preferable to apply a tension of 6.0 mN/dtex or less to the core material. By applying a tension of 6.0 mN/dtex or less to the core material, the core material is prevented from being opened, making it easier to achieve the porosity of the threadlike adhesive body of the present embodiment within the above range.

The tension applied to the core material is preferably 0.2 mN/dtex to 6.0 mN/dtex, and more preferably 0.4 mN/dtex to 5.0 mN/dtex.

### [Uses of Threadlike Adhesive Body]

The threadlike adhesive body of the present embodiment can be stuck to a narrow member or a narrow region while being prevented from protruding, and is also preferably applied to a complex shape such as a curved line, a curved surface, and an uneven shape, and is also preferred in terms of easy disassembly (rework). Furthermore, because of excellent adhesive strength thereof, the threadlike adhesive body can be used to adhere various items.

For example, the threadlike adhesive body of the present embodiment can be suitably used for fixing an article during production of an electronic device and fixing vehicle-mounted components, and can be applied to fixing of a narrow frame of a mobile terminal such as a mobile phone or a smartphone, and fixing of batteries, motors, and the like.

For example, when an adhesive tape is stuck to an adherend having a part with a complicated shape such as a curved line, a curved surface, or an uneven shape, a wrinkle or overlapping may occur in the adhesive tape in such a part, and it is difficult to finely stick the adhesive tape while preventing a protrusion, and the part where a wrinkle or overlapping occurs may cause a decrease in the adhesive strength. In order to stick the adhesive tape while preventing the occurrence of a wrinkle or overlapping, it is conceivable to stick the adhesive tape after finely cutting the adhesive tape. However, workability significantly deteriorates. On the other hand, the threadlike adhesive body of the present embodiment can be firmly stuck without causing a wrinkle or overlapping even when being stuck to a part having a complicated shape such as a curved line, a curved surface, and an uneven shape. Further, since such a threadlike adhesive body can be stuck to a part to be stuck at one time, that is, in one step, the threadlike adhesive body is excellent in workability and can be applied to an automation line.

Specifically, the threadlike adhesive body of the present embodiment can be suitably used, for example, for fixing cables such as electric wires and optical fibers, optical fiber sensors such as LED fiber light and Fiber Bragg Gratings (FBG), various wire members (linear members) such as a yarn, a string, and a wire, and narrow members, in a desired form.

Even in a case where a wire member or a narrow member is fixed to another member in a complicated shape, the threadlike adhesive body of the present embodiment can be firmly fixed with excellent workability while suppressing protrusion, wrinkles, and overlapping in accordance with the complicated shape that the wire member or the narrow member have. Note that in a case where the wire member or the narrow member is fixed to another member, the threadlike adhesive body of the present embodiment is stuck in advance in accordance with a form in which the wire member or the narrow member is to be fixed on a surface of the another member, and then, the wire member or the narrow member can be bonded and fixed in accordance with the threadlike adhesive body stuck to the surface of the another member. Alternatively, the threadlike adhesive body of the present embodiment is stuck to a wire member or a narrow member, and then, the wire member or the narrow member may be fixed to another member in a desired form.

The threadlike adhesive body of the present embodiment can also be suitably used for temporary fixing (temporary tacking) of an article for temporarily fixing (temporarily tacking) one article to a surface of another article. More specifically, the threadlike adhesive body of the present embodiment can be used for temporary fixing (temporary tacking) during production process of, for example, fiber products and leather products such as clothes, shoes, bags, and hats. However, the uses are not limited to these examples, and the threadlike adhesive body is suitably used for various applications in which temporary fixing (temporary tacking) is desired.

For example, when one article is fixed to a surface of the other article, the one article is temporarily fixed and positioned on the surface of the other article in advance using the threadlike adhesive body, and then both articles are fixed (finally fixed) by a fixing method such as thermocompression bonding and sewing. In this case, the threadlike adhesive body of the present embodiment easily and temporarily fixes the two articles without a fixing portion provided between the two articles. For example, in a case where a fiber product or a leather product is sewn, when temporary fixing is performed using the threadlike adhesive body, the temporary fixing can be easily performed while avoiding a part to be sewed, and the pressure-sensitive adhesive can be easily prevented from adhering to a needle.

In addition, the threadlike adhesive body of the present embodiment can be well stuck while preventing a protrusion, a wrinkle, and overlapping even when shapes of two articles are a complicated shape such as a curved line, a curved surface, and an uneven shape. Further, the threadlike adhesive body can be stuck in one step, and workability is good.

Even in a case of an easily deformable member, such as fabric, cloth, and leather that forms a fiber product or a leather product, temporary fixing can be performed using the threadlike adhesive body of the present embodiment, so that deformation of the member due to tension can be prevented, and design aesthetics after fixing (final fixing) is improved. Further, after two articles are fixed (finally fixed) using the threadlike adhesive body of the present embodiment, the threadlike adhesive body of the present embodiment can be pulled out and removed if necessary from the two articles that are fixed (finally fixed). In this case, the adhesive can be prevented from squeezing out, and deterioration of design aesthetics due to aging discoloration of the remaining adhesive can be satisfactorily prevented.

The threadlike adhesive body of the present embodiment can be twisted with a yarn made of other materials to form a composite yarn or can be woven with a yarn or cloth (including nonwoven fabrics and sheets) made of other materials, thereby function combination can be achieved.

Furthermore, the threadlike adhesive body of the present embodiment can be used as a dam material for preventing squeezing out of a glue or an adhesive when a glue or an adhesive is applied to an adhesion object (adherend). The dam material can be used, for example, to prevent squeezing out of a sealing resin used for bonding an optical panel. In the case where the threadlike adhesive body is used as a dam material, the threadlike adhesive body may be peeled off or remain after the glue or the adhesive is cured.

As described above, the following matters are disclosed in the present specification.

<1>

A threadlike adhesive body, containing:
a core material; and
an adhesive, in which
an area ratio in a cross section of the threadlike adhesive body calculated by the following Formula (1) is 0.2 to 1.0.

$$( Area ratio ) = ( Area of adhesive ) / ( Area of core material ) \qquad ( 1 )$$

<2>

The threadlike adhesive body according to <1>, in which
the number of filaments contained in the core material is four or more.
   <3>

The threadlike adhesive body according to <1> or <2>, in which
a porosity in the cross section of the threadlike adhesive body is 20 area % or less.
   <4>

The threadlike adhesive body according to any one of <1> to <3>, in which
the number of twists of the core material is 1 twist/m to 500 twists/m.
   <5>

The threadlike adhesive body according to any one of <1> to <4>, in which
an elastic modulus of the adhesive at 23° C. is 1.0×10³ Pa to 1.0×10⁷ Pa.

### EXAMPLES

The present invention will be described in more detail below with reference to examples, but the present invention is not limited to the following examples in any way.

### [Production Example 1] Preparation of Acrylic Adhesive (Coating Liquid 1)

Into a reaction vessel equipped with a cooling tube, a nitrogen introduction tube, a thermometer, and a stirrer, 40 parts by mass of ion-exchanged water was added, and stirring was performed at 60° C. for 1 hour or more while introducing nitrogen gas to carry out nitrogen substitution. To this reaction vessel, 0.1 part by mass of 2,2′-azobis [N-(2-carboxyethyl)-2-methylpropionamidine]n hydrate (polymerization initiator) was added. While the reaction solution was maintained at 60° C., a monomer emulsion A described below was gradually added dropwise thereto over 4 hours to allow an emulsion polymerization reaction to proceed.

Examples of the monomer emulsion A include an emulsion obtained by adding 85 parts by mass of 2-ethylhexyl acrylate, 13 parts by mass of methyl acrylate, 1.25 parts by mass of acrylic acid, 0.75 parts by mass of methacrylic acid, 0.05 parts by mass of lauryl mercaptan (chain transfer agent), 0.02 parts by mass of γ-methacryloxypropyltrimethoxysilane (manufactured by Shin-Etsu Chemical Co., Ltd., trade name: “KBM-503”), and 2 parts by mass of sodium polyoxyethylene lauryl sulfate (emulsifier) to 30 parts by mass of ion-exchanged water.

After the dropwise addition of the monomer emulsion A was completed, the reaction solution was kept at 60° C. for 3 hours and then cooled to room temperature. The reaction solution was cooled to room temperature, and the pH thereof was adjusted to 7 by adding 10% aqueous ammonia thereto, to obtain an acrylic polymer emulsion 1 (water-dispersible acrylic polymer).

An adhesive-imparting resin emulsion (manufactured by Arakawa Chemical Industries, Ltd., trade name: “Super Ester E-865NT”) was added so that the adhesive-imparting resin was 32 parts by mass per 100 parts by mass of the acrylic polymer contained in the acrylic polymer emulsion 1. Further, ion-exchanged water was added to adjust a solid content concentration thereof to 50 mass %, so as to obtain the coating liquid 1.

### <Storage Elastic Modulus of Adhesive>

A storage elastic modulus of the adhesive was determined by the following method using a dynamic viscoelasticity measuring device (“ARES-G2 Rheometer” manufactured by TA Instruments).

The above obtained coating liquid 1 was applied onto a release liner and dried to form an adhesive layer with a thickness of 20 μm on the release liner. The adhesive layer was laminated to a thickness of about 1 mm, and then punched out to a diameter of 7.9 mm to prepare a cylindrical pellet, which was used as a sample for measuring viscoelasticity. The measurement sample was fixed to a parallel plate fixture with a diameter of 7.9 mm, and a storage elastic modulus G′ was measured under the following conditions using the dynamic viscoelasticity measuring device. From results thereof, the storage elastic modulus G′ at 23° C. was read.
Measurement: Shear mode
Temperature range:−70° C. to 150° ° C.
Heating rate: 5° C./min
Frequency: 1 Hz
Under the above measurement conditions, the elastic modulus of the coating liquid 1 after drying at 23° C. was 9.38×10⁴ Pa.

### [Production Example 2] Preparation of Acrylic Adhesive (Coating Liquid 2)

A coating liquid 2 was obtained in the same manner as in Production Example 1, except that the amount of the adhesive-imparting resin emulsion (manufactured by Arakawa Chemical Industries, Ltd., trade name: “Super Ester E-865NT”) added was set so that the adhesive-imparting resin is 10 parts by mass per 100 parts by mass of the acrylic polymer contained in the acrylic polymer emulsion.

When measured in the same manner as for the coating liquid 1, the elastic modulus of the coating liquid 2 after drying was 5.72×10⁴ Pa.

### [Production Example 3] Preparation of Acrylic Adhesive (Coating Liquid 3)

A coating liquid 3 was obtained in the same manner as in Production Example 1, except that the adhesive-imparting resin emulsion was changed to “Tamanol E200NT” manufactured by Arakawa Chemical Industries, Ltd., and the amount thereof added was set so that the adhesive-imparting resin is 35 parts by mass per 100 parts by mass of the acrylic polymer contained in the acrylic polymer emulsion.

When measured in the same manner as for the coating liquid 1, the elastic modulus of the coating liquid 3 after drying was 7.85×10⁴ Pa.

### [Production Example 4] Preparation of Acrylic Adhesive (Coating Liquid 4)

Into a reaction vessel equipped with a cooling tube, a nitrogen introduction tube, a thermometer, and a stirrer, 40 parts by mass of ion-exchanged water was added, and stirring was performed at 60° C. for 1 hour or more while introducing nitrogen gas to carry out nitrogen substitution. To this reaction vessel, 0.1 part by mass of 2,2′-azobis [N-(2-carboxyethyl)-2-methylpropionamidine]n hydrate (polymerization initiator) was added. While the reaction solution was maintained at 60° C., a monomer emulsion B described below was gradually added dropwise thereto over 4 hours to allow an emulsion polymerization reaction to proceed.

Examples of the monomer emulsion B include an emulsion obtained by adding 86.6 parts by mass of butyl acrylate, 9.6 parts by mass of 2-ethylhexyl acrylate, 3.8 parts by mass of acrylic acid, 0.055 parts by mass of lauryl mercaptan (chain transfer agent), 0.07 parts by mass of γ-methacryloxypropyltrimethoxysilane (manufactured by Shin-Etsu Chemical Co., Ltd., trade name: “KBM-503”), and 2 parts by mass of sodium polyoxyethylene lauryl sulfate (emulsifier) to 29 parts by mass of ion-exchanged water.

After completion of the dropwise addition of the monomer emulsion B, the reaction solution was further kept at 60° C. for 3 hours and cooled to room temperature, and the pH thereof was then adjusted to 7 by addition of 10% ammonia water to obtain an acrylic polymer emulsion 2 (water-dispersible acrylic polymer).

An adhesive-imparting resin emulsion (manufactured by Arakawa Chemical Industries, Ltd., trade name: “Tamanol E200NT”) was added so that the adhesive-imparting resin was 35 parts by mass per 100 parts by mass of the acrylic polymer contained in the acrylic polymer emulsion 2. Further, ion-exchanged water was added to adjust a solid content concentration thereof to 50 mass %, so as to obtain the coating liquid 4.

When measured in the same manner as for the coating liquid 1, the elastic modulus of the coating liquid 4 after drying was 8.77× 10⁴ Pa.

### Example 1

### <Production of Threadlike Adhesive Body>

As the core material, a multifilament yarn (fineness: 1169 dtex, number of filaments: 336) was prepared by twisting 70 times per meter of seven polyethylene terephthalate (PET) fibers (manufactured by Teijin Frontier Co., Ltd.) (fineness: 167 dtex, number of filaments: 48).

The coating liquid 1 was diluted to adjust a solid content concentration, and the core material was coated by dipping using a coating roller. Thereafter, drying was performed at 100° C. for 1 minute to obtain a threadlike adhesive body with a glue amount of 50 mg/m.

### <Production of Wound Body Using Bobbin>

The obtained threadlike adhesive body was wound up to a length of 30 m with a winding width of 50 mm on a bobbin having an outer diameter of 48 mm, an inner diameter of 38 mm (1.5 inches), and a width of 70 mm to obtain a wound body.

### <Evaluation>

The obtained threadlike adhesive body was evaluated as follows. Results are shown in Table 1.

### (Measurement of Glue Amount)

The glue amount was calculated using the following Formula (2) from a mass W1 [mg/m] per unit length of the polyethylene terephthalate (PET) fiber used as the core material and a mass W2 [mg/m] per unit length of the threadlike adhesive body coated with the adhesive after drying.

$$Glue amount [ mg / m ] = W 2 [ mg / m ] [ mg / m ] \qquad ( 2 )$$

### (Measurement of Area Ratio and Porosity)

The obtained threadlike adhesive was cut to extract a cross section that was free of crushing or distortion in a cross-sectional shape thereof. This threadlike adhesive was dyed by being immersed in a ruthenium solution, and an image of the cross section was obtained by SEM. The obtained image was processed using ternary value conversion software [Image], AVIZO (manufactured by Thermo Fisher Scientific) (Rasband, W. S., ImageJ, U. S. National Institutes of Health, Bethesda, Maryland, USA, http://imagej.nih.gov/ij/, 1997-2012; Schneider, C. A., Rasband, W.S., Eliceiri, K. W. “NIH Image to ImageJ: 25 years of image analysis”. Nature Methods 9, 671-675, 2012)], and the area of the adhesive, the area of the core material, and the area of the voids corresponding to each ternary color portion were determined. Note that the above areas are each calculated as a unitless numerical value.

The area ratio was calculated from proportions of the area of the adhesive and the area of the core material. Furthermore, the porosity in the cross section was calculated from proportions of the area of the voids and a sum of the area of the adhesive, the area of the core material and the area of the voids.

### (Measurement of Self-Adhesive Strength)

A hollow portion of the bobbin was passed over a shaft extending in a horizontal direction, and the resulting wound body was set. Using a tensile tester (“Shimadzu Autograph AG-100M2”, manufactured by Shimadzu Corporation), the threadlike adhesive body was pulled up from the wound body to have a vertical displacement of 175 mm at 23° C. and a tensile speed of 1000 mm/min. From an obtained displacement-stress graph, the top 10 stress values between 0 mm and 175 mm displacement were selected, and an average value thereof was taken as the self-adhesive strength (N).

### (Measurement of Cleavage Peeling Force)

The adhesive strength of the threadlike adhesive body was evaluated by the following cleavage peeling force.

An obtained threadlike adhesive tape was stuck to an acrylonitrile-butadiene-styrene copolymer synthetic resin (ABS resin) plate (W (mm)× D (mm)× H (mm)=30× 60×2) in a shape of a spiral circle with an outer diameter of 25 mm, 5 circuits, a pitch distance of 1.5 mm, and a usage amount of 27 cm. A stainless steel (SUS) plate (W (mm)× D (mm)× H (mm)=30× 30×3) was further placed thereon and pressed with a press under a pressure of 0.35 MPa for seconds to obtain a joined body for evaluation.

The obtained joined body for evaluation was set in the tensile tester (“Shimadzu Autograph AG-100M2” manufactured by Shimadzu Corporation), and the ABS resin plate and the SUS plate were peeled off in a direction perpendicular to planes of the plates under conditions of 23° C. and a tensile speed of 300 mm/min, and an obtained stress value was defined as the cleavage peeling force (N).

### Examples 2 and 4

The threadlike adhesive bodies of Examples 2 and 4 were obtained in the same manner as in Example 1, except that the coating liquid 1 was diluted to adjust the solid content concentration thereof, and a fiber opening step was performed before the dipping step using a coating roller, so that the glue amount, the area ratio, and the porosity thereof were as shown in Table 1.

Evaluation results are shown in Table 1.

### Example 3

The threadlike adhesive body of Example 3 was obtained in the same manner as in Example 1, except that the coating liquid 1 was diluted to adjust the solid content concentration thereof, so that the glue amount, the area ratio, and the porosity thereof were as shown in Table 1.

Evaluation results are shown in Table 1.

### Example 5

The threadlike adhesive body of Example 5 was obtained in the same manner as in Example 1, except that the coating liquid 2 was diluted to adjust the solid content concentration thereof, so that the glue amount, the area ratio, and the porosity thereof were as shown in Table 1.

Evaluation results are shown in Table 1.

TABLE 1

| | | Example 1 | Example 2 | Example 3 | Example 4 | Example 5 |
|---|---|---|---|---|---|---|
| Yarn | Fineness [dtex] | 1169 | 1169 | 1169 | 1169 | 1169 |
| | Number of filaments [/] | 336 | 336 | 336 | 336 | 336 |
| | Number of twists [twist/m] | 70 | 70 | 70 | 70 | 70 |
| Adhesive | Coating liquid | Coating | Coating | Coating | Coating | Coating |
| | | liquid 1 | liquid 1 | liquid 1 | liquid 1 | liquid 2 |
| | Elastic modulus [Pa] (23° C.) | 9.38 × 10⁴ | 9.38 × 10⁴ | 9.38 × 10⁴ | 9.38 × 10⁴ | 5.72 × 10⁴ |
| Threadlike | Glue amount [mg/m] | 50 | 52 | 46 | 55 | 55 |
| adhesive | Area of adhesive/area of core | 37/63 | 40/60 | 34/66 | 42/58 | 42/58 |
| body | material | | | | | |
| | Area ratio of adhesive/core | 0.59 | 0.67 | 0.52 | 0.72 | 0.72 |
| | material | | | | | |
| | Porosity [area %] | 8 | 2 | 3 | 7 | 3 |
| Evaluation | Self-adhesive strength [N] | 0.6 | 0.6 | 0.5 | 0.8 | 0.9 |
| | Cleavage peeling force [N/270 | 79 | 80 | 63 | 82 | 58 |
| | mm] | | | | | |

### Examples 6 to 10

The threadlike adhesive bodies of Examples 6 to 10 were obtained in the same manner as in Example 1, except that the coating liquid 1 was diluted to adjust the solid content concentration thereof, so that the glue amount, the area ratio, and the porosity thereof were as shown in Table 2.

Evaluation results are shown in Table 2.

TABLE 2

| | | Example 6 | Example 7 | Example 8 | Example 9 | Example 10 |
|---|---|---|---|---|---|---|
| Yarn | Fineness [dtex] | 1169 | 1169 | 1169 | 1169 | 1169 |
| | Number of filaments [/] | 336 | 336 | 336 | 336 | 336 |
| | Number of twists [twist/m] | 70 | 70 | 70 | 70 | 70 |
| Adhesive | Coating liquid | Coating | Coating | Coating | Coating | Coating |
| | | liquid 1 | liquid 1 | liquid 1 | liquid 1 | liquid 1 |
| | Elastic modulus [Pa] (23° C.) | 9.38 × 10⁴ | 9.38 × 10⁴ | 9.38 × 10⁴ | 9.38 × 10⁴ | 9.38 × 10⁴ |
| Threadlike | Glue amount [mg/m] | 31 | 30 | 62 | 53 | 30 |
| adhesive | Area of adhesive/area of core | 30/70 | 23/77 | 48/52 | 41/59 | 25/75 |
| body | material | | | | | |
| | Area ratio of adhesive/core | 0.43 | 0.30 | 0.92 | 0.69 | 0.33 |
| | material | | | | | |
| | Porosity [area %] | 7 | 13 | 14 | 20 | 25 |
| Evaluation | Self-adhesive strength [N] | 0.3 | 1.0 | 1.2 | 1.2 | 0.8 |
| | Cleavage peeling force [N/270 | 24 | 57 | 55 | 61 | 19 |
| | mm] | | | | | |

### Example 11

The threadlike adhesive body of Example 11 was obtained in the same manner as in Example 1, except that the coating liquid 3 was diluted to adjust the solid content concentration thereof, so that the glue amount, the area ratio, and the porosity thereof were as shown in Table 3.

Evaluation results are shown in Table 3.

### Example 12

The threadlike adhesive body of Example 12 was obtained in the same manner as in Example 1, except that the coating liquid 4 was diluted to adjust the solid content concentration thereof, so that the glue amount, the area ratio, and the porosity thereof were as shown in Table 3.

Evaluation results are shown in Table 3.

### Comparative Example 1

The threadlike adhesive body of Comparative Example 1 was obtained in the same manner as in Example 1, except that the coating liquid 1 was diluted to adjust the solid content concentration thereof, so that the glue amount, the area ratio, and the porosity thereof were as shown in Table 3.

Evaluation results are shown in Table 3. Note that since the threadlike adhesive body of Comparative Example 1 could not bond the ABS resin plate to the SUS plate, it was not possible to evaluate the cleavage peeling force.

### Comparative Example 2

The threadlike adhesive body of Comparative Example 2 was obtained in the same manner as in Example 1, except that the coating liquid 1 was used without being diluted so that the glue amount, the area ratio, and the porosity thereof were as shown in Table 3.

Evaluation results are shown in Table 3.

TABLE 3

| | | | | Comparative | Comparative |
|---|---|---|---|---|---|
| | | Example 11 | Example 12 | Example 1 | Example 2 |
| Yarn | Fineness [dtex] | 1169 | 1169 | 1169 | 1169 |
| | Number of filaments [/] | 336 | 336 | 336 | 336 |
| | Number of twists [twist/m] | 70 | 70 | 70 | 70 |
| Adhesive | Coating liquid | Coating | Coating | Coating | Coating |
| | | liquid 3 | liquid 4 | liquid 1 | liquid 1 |
| | Elastic modulus [Pa] (23° C.) | 7.85 × 10⁴ | 8.77 × 10⁴ | 9.38 × 10⁴ | 9.38 × 10⁴ |
| Threadlike | Glue amount [mg/m] | 50 | 45 | 14 | 96 |
| adhesive | Area of adhesive/area of core | 37/63 | 38/62 | 15/85 | 54/46 |
| body | material | | | | |
| | Area ratio of adhesive/core | 0.59 | 0.61 | 0.18 | 1.17 |
| | material | | | | |
| | Porosity [area %] | 6 | 8 | 10 | 11 |
| Evaluation | Self-adhesive strength [N] | 0.9 | 1.1 | 0.1 | 1.8 |
| | Cleavage peeling force [N/270 | 84 | 82 | Not | 74 |
| | mm] | | | measurable | |

From the results shown in Tables 1 to 3, it can be known that the threadlike adhesive bodies of Examples 1 to 12, whose area ratios are within the predetermined range, maintain excellent adhesive strength and prevent self-adhesion even as a wound body.

In contrast, from the results shown in Table 3, it can be known that the threadlike adhesive bodies of Comparative Examples 1 and 2 whose area ratios fall outside the predetermined range, have problems such as poor adhesive strength, or cannot prevent self-adhesion.

The present invention is not limited to the embodiments described above, and can be made in various modifications within the scope of the claims, and embodiments obtained by appropriately combining technical methods disclosed in different embodiments are also included in the technical scope of the present invention.

Although various embodiments have been described above, the present invention is not limited to these examples. It is apparent that a person skilled in the art could conceive of various changes or modifications within the scope of claims, and these changes or modifications are considered to belong to the technical range of the present invention as a matter of course. Constituent elements of the embodiments described above may be combined at will unless the combinations depart from the spirit of the invention.

Note that, the present application is based on a Japanese Patent Application (No. 2022-181322) filed on Nov. 11, 2022, contents of which are incorporated herein by reference.

### INDUSTRIAL APPLICABILITY

The threadlike adhesive body of the present invention can maintain excellent adhesive strength while preventing self-adhesion even as a wound body, and therefore can be used for, for example, fixing of articles in production of electronic devices, as a threadlike adhesive body that can be stored and transported as a wound body.

1. A threadlike adhesive body, comprising:
a core material; and
an adhesive, wherein
an area ratio in a cross section of the threadlike adhesive body calculated by the following Formula (1) is 0.2 to 1.0, wherein
$$( Area ratio ) = ( Area of adhesive ) / ( Area of core material ) . \qquad ( 1 )$$

2. The threadlike adhesive body according to claim 1, wherein
the number of filaments contained in the core material is four or more.

3. The threadlike adhesive body according to claim 1, wherein
a porosity in the cross section of the threadlike adhesive body is 20 area % or less.

4. The threadlike adhesive body according to claim 1, wherein
the number of twists of the core material is 1 twist/m to 500 twists/m.

5. The threadlike adhesive body according to claim 1, wherein
an elastic modulus of the adhesive at 23° C. is 1.0×10³ Pa to 1.0×10⁷ Pa.

6. The threadlike adhesive body according to claim 2, wherein
a porosity in the cross section of the threadlike adhesive body is 20 area % or less.

7. The threadlike adhesive body according to claim 2, wherein
the number of twists of the core material is 1 twist/m to 500 twists/m.

8. The threadlike adhesive body according to claim 2, wherein
an elastic modulus of the adhesive at 23° C. is 1.0×10³ Pa to 1.0×10⁷ Pa.
